(19) United States
(12) Patent Application Publication
(10) Pub. No.: US 2018/0313462 A1
(43) Pub. Date: Nov. 1, 2018

(54) Flow Rate Control Valve

(71) Applicant: AISIN SEIKI KABUSHIKI KAISHA, Kariya-shi (JP)

(72) Inventors: Masafumi Yoshida, Konan-shi (JP); Tadayoshi Sato, Chita-gun (JP)

(73) Assignee: AISIN SEIKI KABUSHIKI KAISHA, Kariya-shi (JP)

(21) Appl. No.: 15/945,208

(22) Filed: Apr. 4, 2018

(30) Foreign Application Priority Data
Apr. 27, 2017 (JP) 2017-088133

(51) Int. Cl. F16K 31/36

(52) U.S. Cl. CPC F16K 31/36

(57) ABSTRACT

A flow rate control valve includes: a housing having a port formed to allow a fluid to flow between internal and external spaces; and a rotor accommodated in the internal space of the housing rotatably about a rotation axis and having a control hole portion formed in a spherical outer wall portion, wherein the control hole portion is allowed to face the port by setting a rotational position of the rotor so that the fluid is allowed to flow between an inside portion of the rotor and the port, the port includes an annular seal body, and an opening edge of the control hole portion is shaped so that a portion of the opening edge of the control hole portion in contact with the seal body is displaced along the rotation axis in response to rotation operation of the rotor.

### CROSS REFERENCE TO RELATED APPLICATIONS

This application is based on and claims priority under 35 U.S.C. § 119 to Japanese Patent Application 2017-088133, filed on Apr. 27, 2017, the entire contents of which are incorporated herein by reference.

### TECHNICAL FIELD

This disclosure relates to a flow rate control valve that controls a flow rate of a fluid by setting a rotational position of a rotor accommodated in a housing.

### BACKGROUND DISCUSSION

As a flow rate control valve having the configuration described above, in JP 2016-188693A (Reference 1), a technique that accommodates a rotor to be rotatable with respect to the housing in which a discharge port is formed and can discharge a fluid by communicating a control hole portion which is formed on the rotor to have a through hole shape with the discharge port is described.

In Reference 1, an outer wall surface of the rotor is formed in a spherical shape, and on an inner end side of the discharge port, a ring-shaped seal which is in close contact with the outer wall surface of the rotor is provided.

In the flow rate control valve described in Reference 1, a first discharge port (P1 in Reference 1) and a second discharge port (P2 in Reference 1) are formed in the housing, and a common control hole portion (24 in Reference 1) communicating with the first discharge port and the second discharge port is formed in the rotor. In addition, a first seal portion (15 in Reference 1) is provided at an inner end of the first discharge port (P1), and a second seal portion (19 in Reference 1) is provided at an inner end of the second discharge port (P2).

In Reference 1, the second discharge port P2 is smaller in diameter than the first discharge port P1 and, among the operation area of the rotor, a second hole portion (24b in Reference 1) that keeps the second discharge port P2 in a fully opened state is set to be longer than a first hole portion (24a in Reference 1) that keeps the first discharge port P1 in a fully opened state along a rotation direction (circumferential direction) of the rotor.

For this reason, the control hole portion 24 is formed in a shape in which the second discharge port P2 extends in the circumferential direction with respect to the first discharge port P1. However, in a case where the rotor is operated over a long period of time in a structure in which the shape of the control hole portion 24 is formed as described above, the first seal portion 15 may be subject to uneven wear and sealing properties may be deteriorated by the portions other than the first hole portion 24a and the second hole portion 24b being in contact with the first seal portion 15.

Here, as in the comparative example illustrated in FIG. 10, a flow rate control valve is assumed which forms a slit-shaped flow rate adjustment hole portion 101 in a position along a peripheral surface about a rotation axis of the rotor 100 and a circular control hole portion 102 on the outer peripheral surface of the rotor 100 and provided with an annular seal ring 103 with respect to a port P.

FIG. 10 illustrates a control position in which the port P communicates with the control hole portion 102 in the fully opened state at a left end of the drawing, and a position where the port P is completely blocked by the rotation of the rotor 100 is indicated by a two-dot chain line at the right end thereof, and a position where the port P overlaps with the flow rate adjustment hole portion 101 is indicated by a two-dot chain line at the center thereof. In a state where the port P communicates with the control hole portion 102 in a fully opened state, the seal ring 103 is disposed at a position surrounding the control hole portion 102.

In the flow rate control valve illustrated in FIG. 10, the flow rate of the fluid can slightly increase by moving the port P from a completely blocked position along the flow rate adjustment hole portion 101 in accordance with the rotation of the rotor 100. However, in this configuration, when the rotor 100 rotates, since a portion of the seal ring 103 corresponding to the flow rate adjustment hole portion 101 is not almost worn, other portions are worn out.

Therefore, in a case where the uneven wear becomes conspicuous due to using over a long period of time, even if an area of the seal ring 103 where the wear amount is small becomes a form which protrudes to a surface of the rotor 100 and the port P is set to a completely blocked position, the fluid flows in a gap between the seal ring 103 and an outer surface of the rotor 100, and as a result, there is an inconvenience that the fluid is delivered from the port P.

Thus, a need exists for a flow rate control valve which is not susceptible to the drawback mentioned above.

### SUMMARY

According to an aspect of this disclosure, there is provided a flow rate control valve including: a housing having a port that is formed to allow a fluid to flow between an internal space and an external space, and a rotor that is accommodated in the internal space of the housing rotatably about a rotation axis and has a through-hole-shaped control hole portion formed in a spherical outer wall portion, in which the control hole portion is allowed to face the port by setting a rotational position of the rotor so that the fluid is allowed to flow between an inside portion of the rotor and the port, the port includes an annular seal body that is in contact with the outer wall portion, and an opening edge of the control hole portion has a shape that is set so that a portion of the opening edge of the control hole portion in contact with the seal body is displaced in a direction along the rotation axis in response to a rotation operation of the rotor.

According to this characteristic configuration, when the rotation operation of the rotor is performed, the portion of the control hole portion in contact with the seal body is displaced in a direction along the rotation axis, which eliminates the drawback that the opening edge of the control hole portion is continuously in sliding contact with a specific portion of the seal body, so that it is possible to suppress local wear of the seal body and to produce average wear.

Therefore, even when used for a long period of time, the flow rate control valve thus configured can keep good sealing properties without uneven wear of the seal body between the rotor and the port.

According to another aspect of this disclosure, there is provided a flow rate control valve including: a housing having a port that is formed to allow a fluid to flow between an internal space and an external space; and a rotor that is accommodated in the internal space of the housing rotatably about a rotation axis and has a main control hole portion and an adjustment control hole portion that are formed in an outer wall portion, in which the main control hole portion or the adjustment control hole portion is allowed to face the port by setting a rotational position of the rotor so that the fluid is allowed to flow between an inside portion of the rotor and the port, the port includes a seal body that is in contact with the outer wall portion, and an opening edge of the adjustment control hole portion has a shape that is set so that a portion of the opening edge of the adjustment control hole portion in contact with the seal body is displaced in a direction along the rotation axis in response to a rotation operation of the rotor.

According to this, when the rotation operation of the rotor is performed, the portion of the adjustment control hole portion in contact with the seal body is displaced in a direction along the rotation axis, which eliminates the drawback that the opening edge of the adjustment control hole portion is continuously in sliding contact with a specific portion of the seal body, so that it is possible to suppress local wear of the seal body and produce average wear.

Therefore, even when used for a long period of time, the flow rate control valve thus configured can keep good sealing properties without uneven wear of the seal body between the rotor and the port.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a longitudinal sectional view of a flow rate control valve;

FIG. 2 is a cross-sectional view of the flow rate control valve;

FIG. 3 is a perspective view of a rotor;

FIG. 4 is a developed view of the rotor;

FIG. 5 is a developed view of a rotor of another embodiment (a);

FIG. 6 is a developed view of a rotor of another embodiment (b);

FIG. 7 is a developed view of a rotor of another embodiment (c);

FIG. 8 is a developed view of a rotor of another embodiment (d);

FIG. 9 is a developed view of a rotor of another embodiment (e); and

FIG. 10 is a developed view of a rotor of a flow rate control valve of a comparative example.

### DETAILED DESCRIPTION

Hereinafter, embodiments disclosed here will be described with reference to the drawings.

### [Basic Configuration]

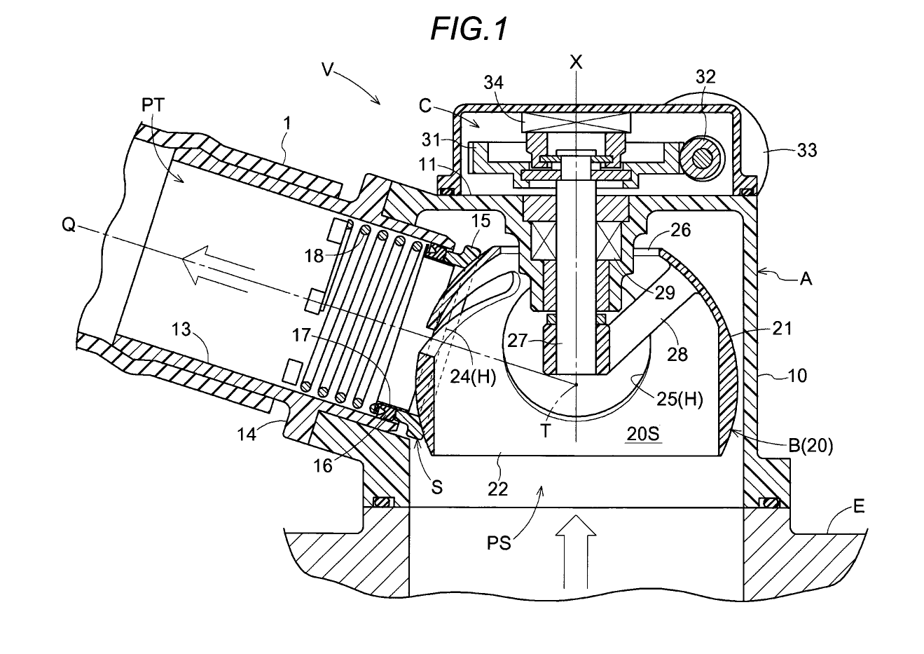

As illustrated in FIG. 1, a flow rate control valve V that includes an introduction port PS which receives cooling water (an example of fluid) from the engine E in a vehicle and a discharge port PT (specific example of port) which feeds cooling water to the radiator is configured.

The flow rate control valve V includes a resin housing A, a resin rotor B which is accommodated in the housing A so as to be rotatable about a rotation axis X and having a spherical outer wall portion 21, and a rotation control portion C which rotates and drives the rotor B.

The vehicle includes a water pump (not illustrated) that supplies cooling water returned from the radiator to a water jacket of the engine E and this flow rate control valve V controls the amount of cooling water supplied to the radiator (not illustrated) from the discharge port PT (specific example of port) by setting a rotation position of the rotor B.

In this embodiment, although the flow rate of the cooling water (fluid) is controlled by the flow rate control valve V, the flow rate of the fluid other than water such as oil, in addition to the cooling water may be controlled.

### [Housing]

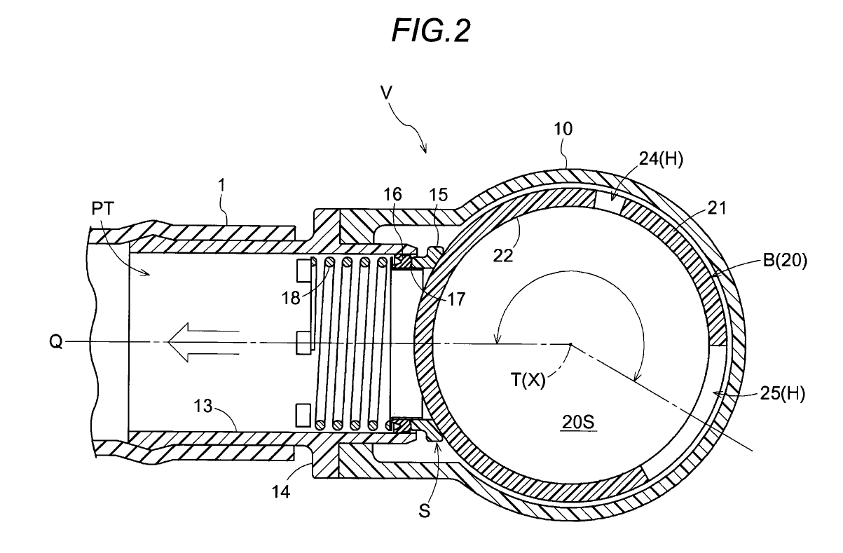

As illustrated in FIGS. 1 and 2, the housing A has a shape in which one end portion of a tubular housing body 10 about the rotation axis X is closed with a housing plate 11, and the introduction port PS is formed in a space on the open side of the housing body 10.

The discharge port PT includes a cylindrical sleeve portion 13 to which a radiator hose 1 is connected, a flange portion 14 which is formed in a flange shape on an outer circumference of the sleeve portion 13, and a seal unit S which is provided at an inner end of the sleeve portion 13. The discharge port PT is configured to allow the flow of cooling water (fluid) between an internal space and an external space of the housing A.

In particular, the position of the sleeve portion 13 is set so that an imaginary straight line obtained by extending a port axis Q at the center of the sleeve portion 13 of the discharge port PT intersects the rotation axis X at a spherical center T of a spherical outer wall portion 21 of the rotor B.

The outer circumference of the flange portion 14 is connected to the housing body 10 by welding over the entire circumference. In place of welding, the flange portion 14 may also adhere to the housing body 10 with an adhesive.

The seal unit S includes an annular seal body 15, an annular packing 16, a cylindrical holder 17, and a compression coil type spring 18. The annular seal body 15, the annular packing 16, the cylindrical holder 17, and the compression coil type spring 18 are arranged on an inner circumference of the inner end position of the sleeve portion 13.

In this seal unit S, the seal body 15 is disposed at a position of being in contact with an outer surface of the outer wall portion 21 of the rotor B, and the packing 16 is disposed at a position of being contact with the side of the seal body 15 which is opposite to the rotor B. In addition, the holder 17 is disposed in an area extending from the inner circumference of the seal body 15 to the packing 16 and the spring 18 is disposed so as to be in contact with a bent portion at an outer end position (position away from rotor B) of the holder 17. The outer end side of the spring 18 abuts against a spring receiving portion protruding formed on the inner circumference of the sleeve portion 13.

From this configuration, the seal body 15, the packing 16, and the holder 17 of the seal unit S can be integrally displaced along the port axis 0, and the urging force of the spring 18 presses the seal body 15 against the outer surface of the outer wall portion 21 of the rotor B.

In a case where the rotor B is set to a position to block the first discharge port P1, the entire circumference of the seal body 15 is in close contact with the spherical outer wall portion 21 and shuts off the flow of the cooling water between the discharge port PT and the outer wall portion 21 of the rotor B. As the seal body 15, a resin having high heat resistance, flexibility and small friction coefficient, such as PTFE (polytetrafluoroethylene), is used.

The packing 16 is formed in an annular shape with a flexible resin such as EPDM (ethylene propylene diene rubber). At the same time that the packing 16 is in contact with the seal body 15, a sealed state between the seal body 15 and the inner surface of the sleeve portion 13 is created by an outer lip portion of the outer circumference being in contact with the inner surface of the sleeve portion 13.

The holder 17 is made of a metal having high rigidity like a stainless steel material and holds a positional relationship between the seal body 15 and the packing 16.

### [Rotor]

As illustrated in FIGS. 1 to 3, the rotor B has a rotor main body 20 integrally rotating with a shaft 27 disposed coaxially with the rotation axis X.

The rotor main body 20 is formed with an outer wall portion 21 having an outer surface which is equidistant from the sphere center T and has a rotor internal space 20S and an opening portion 22 for receiving the cooling water from the introduction port PS into the rotor internal space 20S is formed on the rotor main body 20 by opening in a direction along the rotation axis X.

In addition, a control hole portion H for controlling the amount of cooling water fed from the rotor internal space 20S of the rotor main body 20 to the discharge port PT is formed in a through hole shape. The control hole portion H is configured with an adjustment control hole portion 24 and a main control hole portion 25 which is disposed at a position close to the adjustment control hole portion 24.

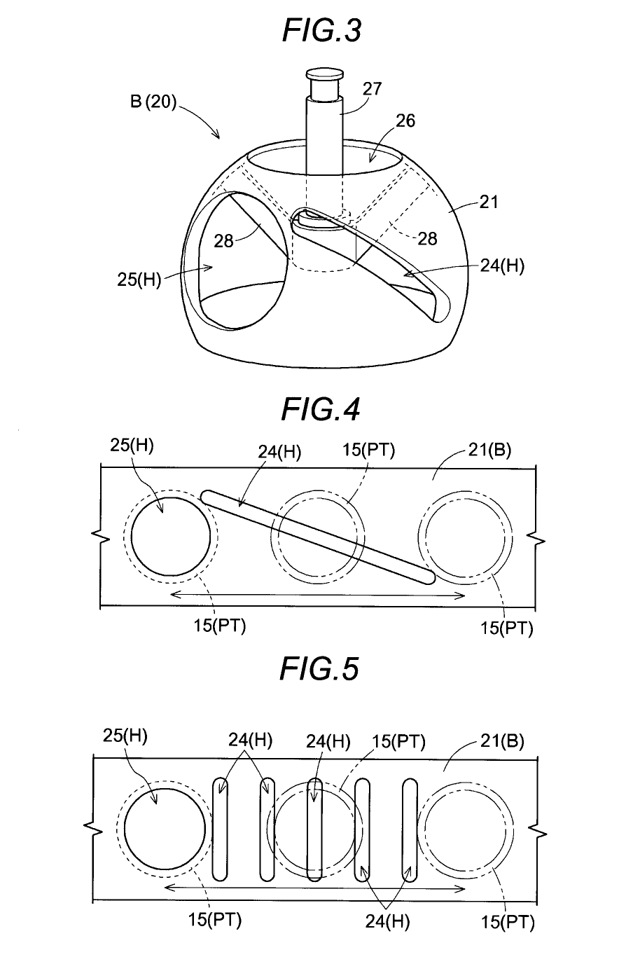

As illustrated in FIGS. 3 and 4, the adjustment control hole portion 24 is formed as a through hole having a diameter equal to an inner diameter of the seal body 15 in a direction along the rotation axis X when viewed in a direction orthogonal to the rotation axis X. The main control hole portion 25 is disposed at a position which can be set coaxially with the port axis Q.

FIG. 4 illustrates the main control position in which the discharge port PT communicates with the main control hole portion 25 in the fully opened state at the left end of the drawing, and illustrates the blocked position in which the discharge port PT is completely blocked (position illustrated at the right end in FIG. 4) and a flow rate adjustment position (position illustrated in center in FIG. 4) in which the discharge port PT communicates with the adjustment control hole portion 24 by two-dot chain lines.

In the flow rate control valve V, in a state where the supply of the cooling water is stopped, the entire seal body 15 of the discharge port PT is in a position to be in contact with the outer surface of the outer wall portion 21 of the rotor main body 20, and the cooling water does not flow to the discharge port PT. In a case of feeding cooling water to the discharge port PT, fine adjustment of the flow rate of the cooling water is made possible by first the adjustment control hole portion 24 facing the discharge port PT by rotating operation of the rotor B. Thereafter, by making the main control hole portion 25 face the discharge port PT, the cooling water increases to be capable of supplying the cooling water in the fully opened state.

In addition, in the rotor main body 20, an opening portion 26 in which the shaft 27 is disposed in a penetration state is formed on the side opposite to the opening portion 22. A plurality of connection bodies 28 formed at a protruding end of the shaft 27 are connected to an inner peripheral surface of the rotor main body 20, and thus the shaft 27 and the rotor B integrally rotate.

### [Rotation Control Portion]

The shaft 27 is rotatably supported by the housing plate 11 in a state of penetrating the housing plate 11 of the housing A and includes a seal portion 29 for preventing leakage of the cooling water between the shaft 27 and a boss portion of the housing plate 11.

The rotation control portion C includes a wheel gear 31 provided at an end portion of the shaft 27, a worm gear 32 for meshing with the wheel gear 31, an electric motor 33 for rotating the worm gear 32, and a non-contact type rotation angle sensor 34 for detecting a rotational position of the rotor B from a rotation position of the worm gear 32.

The wheel gear 31, the worm gear 32, the electric motor 33, and the rotation angle sensor 34 are accommodated in a watertight case, and the electric motor 33 is controlled by an external control device. The control device sets a target position of the rotor B based on information such as the detection result of the water temperature sensor that measures the temperature of the cooling water of the engine E and the rotational position of the rotor B is controlled so as to reach the target position by the detection signal of the rotation angle sensor 34.

### [Control of Cooling Water]

As illustrated in FIG. 4, in a case where the rotor B is set in the blocked position, the seal body 15 of the discharge port PT faces a region of the rotor main body 20 where the control hole portion H is not formed. Accordingly, the flow of the cooling water to the discharge port PT is shut off.

In addition, in a case where the rotor B is set from the blocked position to the flow rate adjustment position, the adjustment control hole portion 24 and the discharge port PT face each other in accordance with position change thereof, and the facing region increases. Accordingly, the flow rate of the cooling water supplied to the discharge port PT increases, and the discharge port PT reaches the flow rate adjustment position illustrated in the center in FIG. 4, so that the flow rate is kept at a fixed value.

In a case where the position of the rotor B is further changed from this flow rate adjustment position to the main control position, both the adjustment control hole portion 24 and the main control hole portion 25 face the discharge port PT in the initial stage of this control, the cooling water is supplied from the adjustment control hole portion 24 to the discharge port PT, and the flow rate of the cooling water supplied from the main control hole portion 25 increases in parallel with this supply. Accordingly, when only the adjustment control hole portion 24 faces the discharge port PT, it is possible to supply more cooling water than the cooling water supplied to the discharge port PT and eventually the discharge port PT is brought into the fully opened state, and cooling water can be discharged by reaching the main control position.

In particular, in the flow rate control valve V, in a case where the rotor B is rotated toward the flow rate adjustment position from a state of being in the rotational position of completely blocking the discharge port PT, although the seal body 15 is in contact with the opening edge of the adjustment control hole portion 24, since the contact position between the opening edge and the seal body 15 is relatively displaced in the direction along the rotation axis X, the specific position of the opening edge is not in contact with a fixed position of the seal body 15.

In other words, since the opening edge of the adjustment control hole portion 24 is in contact with the region including most of the seal body 15 in the radial direction, even in a case of being used over a long period of time, the entire circumference of the seal body 15 is worn average and uneven wear thereof is suppressed. Even if the seal body 15 wears since the pressure contact with the outer wall portion 21 is kept by the urging force of the spring 18, sealing properties of the seal body 15 can be kept. By suppressing uneven wear in this way, in a state where the rotor B is in a rotational position in which the discharge port PT is completely blocked, the entire circumference of the seal body 15 is in close contact with the outer surface of the outer wall portion 21 of the rotor main body 20 without any gap, shutoff of the cooling water can be reliably performed over a long period of time.

### Other Embodiments

In this disclosure, in addition to the embodiment described above, the adjustment control hole portion 24 may be formed as illustrated in other embodiments of the following (a) to (e). In (a) to (e), the fully opened state is illustrated, in which the discharge port PT faces the main control hole portion 25. In each drawing, the discharge port PT in the blocked position is indicated by a two-dot chain line at the right end thereof, and the discharge port PT having the flow rate adjustment position is indicated by a two-dot chain line at the center thereof (those having the same functions as those in the embodiment are denoted by the same reference numerals and symbols as in the embodiment).

(a) As illustrated in FIG. 5, the adjustment control hole portions 24 may be formed as a plurality of slits positioned parallel to the rotation axis X. Also by forming the adjustment control hole portions 24 as illustrated in this drawing, fine adjustment of the flow rate of the cooling water can be performed with the plurality of adjustment control hole portions 24 when the rotor B is shifted from the blocked position to the flow rate adjustment position. Even in the configuration of this further embodiment (a), the opening edge of the adjustment control hole portion 24 is in contact with the region including almost all of the seal body 15 in the radial direction, and thus the entire circumference of the seal body 15 can be worn averagely, so that uneven wear is suppressed.

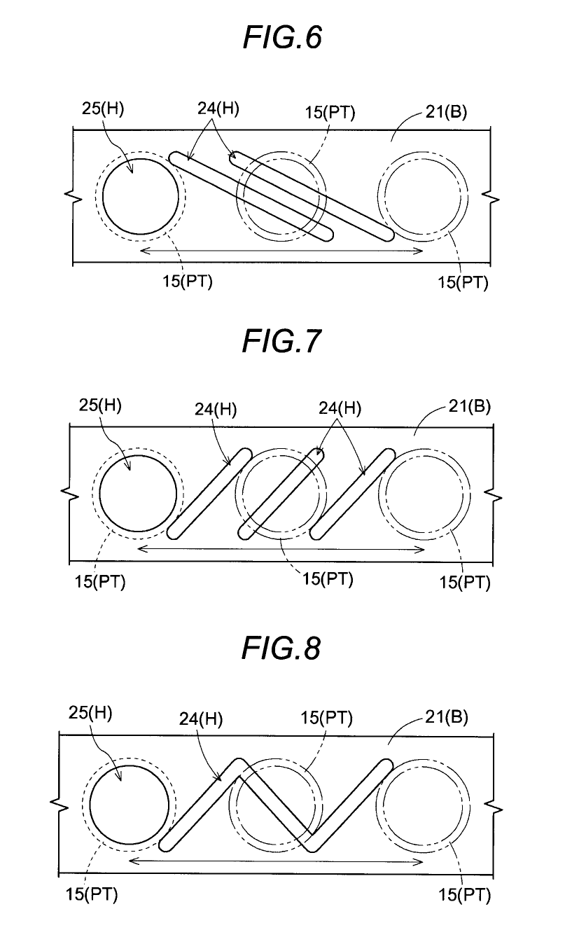

(b) As illustrated in FIG. 6, the adjustment control hole portions 24 may be formed as a plurality of (a pair of) slits which are in an inclined position with respect to the rotation axis X. Also by forming the adjustment control hole portions 24 as illustrated in this drawing, fine adjustment of the flow rate of the cooling water can be performed with the plurality of adjustment control hole portions 24 when the rotor B is shifted from the blocked position to the flow rate adjustment position. Even in the configuration of this further embodiment (b), the opening edges of the plurality of adjustment control hole portions 24 are in contact with the region including almost all of the seal body 15 in the radial direction, and thus the entire circumference of the seal body 15 can be worn averagely, so that uneven wear is suppressed.

(c) As illustrated in FIG. 7, the adjustment control hole portions 24 may be formed as a plurality of slits in an inclined position with respect to the rotation axis X. Also by forming the adjustment control hole portions 24 as illustrated in this drawing, fine adjustment of the flow rate of the cooling water can be performed with the plurality of adjustment control hole portions 24 when the rotor B is shifted from the blocked position to the flow rate adjustment position. Even in the configuration of this further embodiment (c), the opening edges of the plurality of adjustment control hole portions 24 are in contact with the region including almost all of the seal body 15 in the radial direction, and thus the entire circumference of the seal body 15 can be worn averagely, so that uneven wear is suppressed.

(d) As illustrated in FIG. 8, the adjustment control hole portions 24 may be formed as a zigzag slit with respect to the rotation axis X. Also by forming the adjustment control hole portions 24 as illustrated in this drawing, fine adjustment of the flow rate of the cooling water can be performed with the plurality of adjustment control hole portions 24 when the rotor B is shifted from the blocked position to the flow rate adjustment position. Even in the configuration of this further embodiment (d), the opening edges of the plurality of adjustment control hole portions 24 are in contact with the region including almost all of the seal body 15 in the radial direction, and thus the entire circumference of the seal body 15 can be worn averagely, so that uneven wear is suppressed.

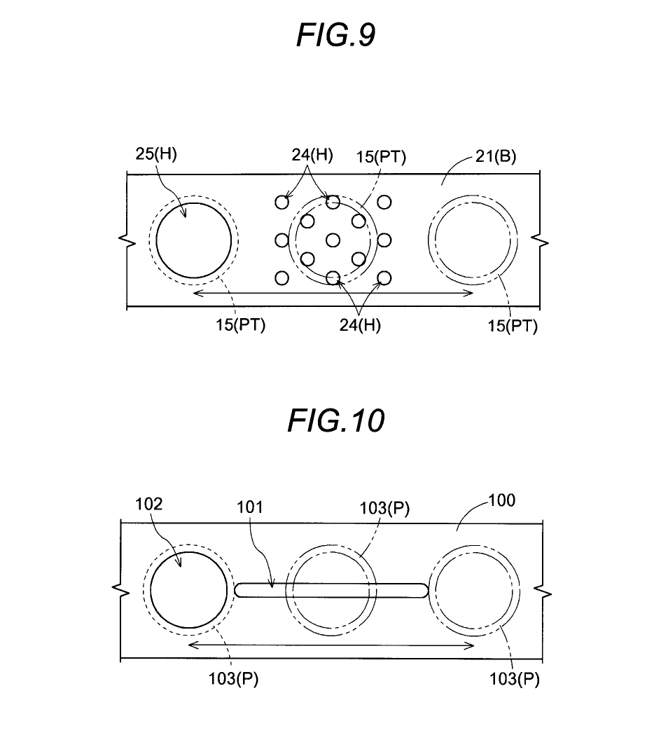

(e) As illustrated in FIG. 9, the adjustment control hole portions 24 may be formed as a plurality of small diameter through holes. Also by forming the adjustment control hole portions 24 as illustrated in this drawing, fine adjustment of the flow rate of the cooling water can be performed with the plurality of adjustment control hole portions 24 when the rotor B is shifted from the blocked position to the flow rate adjustment position. Even in the configuration of this further embodiment (e), the opening edges of the plurality of adjustment control hole portions 24 are in contact with the region including almost all of the seal body 15 in the radial direction, and thus the entire circumference of the seal body 15 can be worn averagely, so that uneven wear is suppressed. Also in the case where the adjustment control hole portions 24 are formed as a plurality of small-diameter through holes as described above, the diameter of the through holes may be made larger than that illustrated in FIG. 9 so that the seal body 15 can necessarily pass through the site of the through holes when the rotor B rotates.

(f) For example, the slit width, of the adjustment control hole portion 24 described in the embodiment or the adjustment control hole portions 24 illustrated in the further embodiments (b) and (c) may be increased with the shift from the blocked position to the flow rate adjustment position. This configuration can expand the adjustment range of the flow rate.

(g) A plurality of discharge ports PT may be formed for the housing A, and control hole portions H corresponding thereto may be formed in the outer wall portion 21 of the rotor B. This configuration allows setting of the flow rate of the fluid to be supplied to the plurality of supply targets.

This disclosure can be applied to a flow rate control valve that controls the flow rate of a fluid by setting the rotational position of the rotor accommodated in the housing.

According to an aspect of this disclosure, there is provided a flow rate control valve including: a housing having a port that is formed to allow a fluid to flow between an internal space and an external space, and a rotor that is accommodated in the internal space of the housing rotatably about a rotation axis and has a through-hole-shaped control hole portion formed in a spherical outer wall portion, in which the control hole portion is allowed to face the port by setting a rotational position of the rotor so that the fluid is allowed to flow between an inside portion of the rotor and the port, the port includes an annular seal body that is in contact with the outer wall portion, and an opening edge of the control hole portion has a shape that is set so that a portion of the opening edge of the control hole portion in contact with the seal body is displaced in a direction along the rotation axis in response to a rotation operation of the rotor.

According to this characteristic configuration, when the rotation operation of the rotor is performed, the portion of the control hole portion in contact with the seal body is displaced in a direction along the rotation axis, which eliminates the drawback that the opening edge of the control hole portion is continuously in sliding contact with a specific portion of the seal body, so that it is possible to suppress local wear of the seal body and to produce average wear.

Therefore, even when used for a long period of time, the flow rate control valve thus configured can keep good sealing properties without uneven wear of the seal body between the rotor and the port.

In the flow rate control valve according to the aspect of this disclosure, the control hole portion may be formed in a slit shape inclined with respect to the rotation axis.

According to this, the opening edges of the control hole portion can have a parallel position to each other, so that by making the width of the opening edges smaller than the outer diameter of the seal body, it is possible to suppress the falling off of the seal body. In addition, when the rotor is operated to rotate, a pair of opening edges of the control hole portion can be moved at the same displacement speed in a direction along the rotation axis with respect to the seal body, and thus uneven wear of the seal body can be suppressed. Furthermore, when the control hole portion is formed in a slit shape, the flow rate of the fluid with respect to the rotation amount of the rotor can also be adjusted by making one slit width different from another slit width.

In the flow rate control valve according to the aspect of this disclosure, a plurality of the control hole portions in slit shapes may be formed in a positional relationship where the plurality of the control hole portions do not intersect each other.

According to this, for example, when the plurality of the control hole portions are formed in an adjacent positional relationship to each other, the required flow rate can be controlled even if the width (slit width) of each control hole portion is small.

In the flow rate control valve according to the aspect of this disclosure, a plurality of the control hole portions in slit shapes may be formed in a positional relationship where the plurality of the control hole portions are not parallel to each other.

According to this configuration, for example, when two adjacent slits are formed so that a fluid can flow simultaneously through the two adjacent slits and sent to the port, the interval between the adjacent slits can be increased or decreased in response to the rotation of the rotor by setting an angle in the direction (longitudinal direction) where the adjacent slits are formed, so that the flow rate of the fluid can be changed with respect to the rotation amount of the rotor.

In the flow rate control valve according to the aspect of this disclosure, a plurality of the control hole portions may be formed in slit shapes parallel to the rotation axis when viewed in a direction orthogonal to the rotation axis.

According to this, the contact position of the seal body with respect to the plurality of slit-shaped control hole portions can be changed in the radial direction to suppress uneven wear of the seal body.

In the flow rate control valve according to the aspect of this disclosure, a length of the opening edge of the control hole portion in the rotation axis direction may be set to be equal to or longer than a length of the seal body in the rotation axis direction.

According to this, the entire portion of the seal body can be worn, and thus a step can be prevented from forming between worn and unworn portions of the seal body, so that leakage of the fluid due to a stepped portion can be suppressed.

According to another aspect of this disclosure, there is provided a flow rate control valve including: a housing having a port that is formed to allow a fluid to flow between an internal space and an external space; and a rotor that is accommodated in the internal space of the housing rotatably about a rotation axis and has a main control hole portion and an adjustment control hole portion that are formed in an outer wall portion, in which the main control hole portion or the adjustment control hole portion is allowed to face the port by setting a rotational position of the rotor so that the fluid is allowed to flow between an inside portion of the rotor and the port, the port includes a seal body that is in contact with the outer wall portion, and an opening edge of the adjustment control hole portion has a shape that is set so that a portion of the opening edge of the adjustment control hole portion in contact with the seal body is displaced in a direction along the rotation axis in response to a rotation operation of the rotor.

According to this, when the rotation operation of the rotor is performed, the portion of the adjustment control hole portion in contact with the seal body is displaced in a direction along the rotation axis, which eliminates the drawback that the opening edge of the adjustment control hole portion is continuously in sliding contact with a specific portion of the seal body, so that it is possible to suppress local wear of the seal body and produce average wear.

Therefore, even when used for a long period of time, the flow rate control valve thus configured can keep good sealing properties without uneven wear of the seal body between the rotor and the port.

In the flow rate control valve according to the other aspect of this disclosure, the adjustment control hole portion may be formed in a shape inclined with respect to the rotation axis.

According to this, it is possible to suppress local wear of the seal body and to produce average wear using such a simple shape that the adjustment control hole portion is inclined with respect to the rotation axis.

In the flow rate control valve according to the other aspect of this disclosure, a length of the opening edge of the adjustment control hole portion in the rotation axis direction may be set to be equal to or longer than a length of the seal body in the rotation axis direction.

According to this, the entire portion of the seal body can be worn, and thus a step can be prevented from forming between worn and unworn portions of the seal body, so that leakage of the fluid due to a stepped portion can be suppressed.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A flow rate control valve comprising:
a housing having a port that is formed to allow a fluid to flow between an internal space and an external space; and
a rotor that is accommodated in the internal space of the housing rotatably about a rotation axis and has a through-hole-shaped control hole portion formed in a spherical outer wall portion,
wherein the control hole portion is allowed to face the port by setting a rotational position of the rotor so that the fluid is allowed to flow between an inside portion of the rotor and the port,
the port includes an annular seal body that is in contact with the outer wall portion, and
an opening edge of the control hole portion has a shape that is set so that a portion of the opening edge of the control hole portion in contact with the seal body is displaced in a direction along the rotation axis in response to a rotation operation of the rotor.

2. The flow rate control valve according to claim 1,
wherein the control hole portion is formed in a slit shape inclined with respect to the rotation axis.

3. The flow rate control valve according to claim 2,
wherein a plurality of the control hole portions in slit shapes are formed in a positional relationship where the plurality of the control hole portions do not intersect each other.

4. The flow rate control valve according to claim 2,
wherein a plurality of the control hole portions in slit shapes are formed in a positional relationship where the plurality of the control hole portions are not parallel to each other.

5. The flow rate control valve according to claim 1,
wherein a plurality of the control hole portions are formed in slit shapes parallel to the rotation axis when viewed in a direction orthogonal to the rotation axis.

6. The flow rate control valve according to claim 1,
wherein a length of the opening edge of the control hole portion in the rotation axis direction is set to be equal to or longer than a length of the seal body in the rotation axis direction.

7. A flow rate control valve comprising:
a housing having a port that is formed to allow a fluid to flow between an internal space and an external space; and
a rotor that is accommodated in the internal space of the housing rotatably about a rotation axis and has a main control hole portion and an adjustment control hole portion that are formed in an outer wall portion,
wherein the main control hole portion or the adjustment control hole portion is allowed to face the port by setting a rotational position of the rotor so that the fluid is allowed to flow between an inside portion of the rotor and the port,
the port includes a seal body that is in contact with the outer wall portion, and
an opening edge of the adjustment control hole portion has a shape that is set so that a portion of the opening edge of the adjustment control hole portion in contact with the seal body is displaced in a direction along the rotation axis in response to a rotation operation of the rotor.

8. The flow rate control valve according to claim 7,
wherein the adjustment control hole portion is formed in a shape inclined with respect to the rotation axis.

9. The flow rate control valve according to claim 7,
wherein a length of the opening edge of the adjustment control hole portion in the rotation axis direction is set to be equal to or longer than a length of the seal body in the rotation axis direction.
